(19) United States
(12) Patent Application Publication
(10) Pub. No.: US 2020/0014931 A1
(43) Pub. Date: Jan. 9, 2020

(54) Methods and Apparatuses of Generating an Average Candidate for Inter Picture Prediction in Video Coding Systems

(71) Applicant: MEDIATEK INC., Hsinchu City (TW)

(72) Inventors: Yu-Ling HSIAO, Hsinchu City (TW); Tzu-Der CHUANG, Hsinchu City (TW); Chih-Wei HSU, Hsinchu City (TW); Ching-Yeh CHEN, Hsinchu City (TW)

(21) Appl. No.: 16/503,575

(22) Filed: Jul. 4, 2019

Related U.S. Application Data
(60) Provisional application No. 62/741,246, filed on Oct. 4, 2018.
(60) Provisional application No. 62/740,568, filed on Oct. 3, 2018.
(60) Provisional application No. 62/694,557, filed on Jul. 6, 2018.

(51) Int. Cl. H04N 19/139; H04N 19/176; H04N 19/105; H04N 19/517

(52) U.S. Cl. CPC H04N 19/139; H04N 19/517; H04N 19/105; H04N 19/176

(57) ABSTRACT

Video processing methods and apparatuses for coding a current block by constructing a candidate set including at least a motion candidate and at least an average candidate. The average candidate is derived from motion information of neighboring blocks, and at least one neighboring block used to derive the average candidate is a temporal block in a temporal collocated picture. Each of the neighboring blocks is a spatial neighboring block in a current picture or a temporal block in the temporal collocated picture. A selected candidate is determined from the candidate set as a motion vector predictor for encoding or decoding a motion vector of the current block.

### CROSS REFERENCE TO RELATED APPLICATIONSu65t

The present invention claims priority to U.S. Provisional Patent Application, Ser. No. 62/694,557, filed on Jul. 6, 2018, entitled “Method of Averaged MV in Inter Mode and Merge Mode Coding”, U.S. Provisional Patent Application, Ser. No. 62/740,568, filed on Oct. 3, 2018, entitled “Average MVPs or Average Merge Candidates Pruning in Video Coding”, and U.S. Provisional Patent Application, Ser. No. 62/741,246, filed on Oct. 4, 2018, entitled “Method of Averaged MV and sub-block mode in Inter Mode and Merge Mode Coding”. The U.S. Provisional Patent Applications are hereby incorporated by reference in their entireties.

### FIELD OF THE INVENTION

The present invention relates to video processing methods and apparatuses in video encoding and decoding systems. In particular, the present invention relates to generating an average candidate from motion information of neighboring blocks for inter picture prediction.

### BACKGROUND AND RELATED ART

The High-Efficiency Video Coding (HEVC) standard is the latest video coding standard developed by the Joint Collaborative Team on Video Coding (JCT-VC) group of video coding experts from ITU-T Study Group. The HEVC standard improves the video compression performance of its proceeding standard H.264/AVC to meet the demand for higher picture resolutions, higher frame rates, and better video qualities. The HEVC standard relies on a block-based coding structure which divides each video slice into multiple square Coding Tree Units (CTUs), where a CTU is the basic unit for video compression in HEVC. In the HEVC main profile, minimum and the maximum sizes of a CTU are specified by syntax elements signaled in the Sequence Parameter Set (SPS). A raster scan order is used to encode or decode CTUs in each slice. Each CTU may contain one Coding Unit (CU) or recursively split into four smaller CUs according to a quad-tree partitioning structure until a predefined minimum CU size is reached. At each depth of the quad-tree partitioning structure, an N×N block is either a single leaf CU or split into four blocks of sizes N/2×N/2, which are coding tree nodes. If a coding tree node is not further split, it is the leaf CU. The leaf CU size is restricted to be larger than or equal to the predefined minimum CU size, which is also specified in the SPS.

The prediction decision is made at the CU level, where each CU is coded using either inter picture prediction or intra picture prediction. Once the splitting of CU hierarchical tree is done, each CU is subject to further split into one or more Prediction Units (PUs) according to a PU partition type for prediction. The PU works as a basic representative block for sharing prediction information as the same prediction process is applied to all pixels in the PU. The prediction information is conveyed to the decoder on a PU basis. Motion estimation in inter picture prediction identifies one (uni-prediction) or two (bi-prediction) best reference blocks for a current block in one or two reference picture, and motion compensation in inter picture prediction locates the one or two best reference blocks according to one or two motion vectors (MVs). A difference between the current block and a corresponding predictor is called prediction residual. The corresponding predictor is the best reference block when uni-prediction is used. When bi-prediction is used, the two reference blocks are combined to form the predictor. The prediction residual belong to a CU is split into one or more Transform Units (TUs) according to another quad-tree block partitioning structure for transforming residual data into transform coefficients for compact data representation. The TU is a basic representative block for applying transform and quantization on the residual data. For each TU, a transform matrix having the same size as the TU is applied to the residual data to generate transform coefficients, and these transform coefficients are quantized and conveyed to the decoder on a TU basis.

The terms Coding Tree Block (CTB), Coding block (CB), Prediction Block (PB), and Transform Block (TB) are defined to specify two dimensional sample array of one color component associated with the CTU, CU, PU, and TU respectively. For example, a CTU consists of one luma CTB, two corresponding chroma CTBs, and its associated syntax elements.

Inter Picture Prediction Modes There are three inter picture prediction modes in HEVC, including Inter, Skip, and Merge modes. Motion vector prediction is used in these inter picture prediction modes to reduce bits required for motion information coding. The motion vector prediction process includes generating a candidate set including multiple spatial and temporal motion candidates and pruning the candidate set to remove redundancy. A Motion Vector Competition (MVC) scheme is applied to select a final motion candidate among the candidate set. Inter mode is also referred to as Advanced Motion Vector Prediction (AMVP), where inter prediction indicators, reference picture indices, Motion Vector Differences (MVDs), and prediction residual are transmitted when encoding a PU in Inter mode. The inter prediction indicator of a PU describes the prediction direction such as list 0 prediction, list 1 prediction, or bi-directional prediction. An index is also transmitted for each prediction direction to select one motion candidate from the candidate set. A default candidate set for the Inter mode includes two spatial motion candidates and one temporal motion candidate. FIG. 1 illustrates locations of the motion candidates for deriving a candidate set for a PB 10 coded in Inter mode, Skip mode, or Merge mode. The two spatial motion candidates in the candidate set for Inter mode include a left candidate and a top candidate. The left candidate for the current PB 10 is searched from below left to left, from block A₀ 111 to block A₁ 112, and the MV of the first available block is selected as the left candidate, while the top candidate is searched from above right to above left, from block B₀ 113, to block B₁ 114, and then block B₂ 115, and the MV of the first available block is selected as the top candidate. A block having motion information, or in other words, a block coded in inter picture prediction, is defined as an available block. The temporal motion candidate is the MV of a first available block selected from block T_{BR} 121 adjacent to a bottom-right corner of a collocated block 12 and block T_{CTR} 122 inside the collocated block 12 in a reference picture. The reference picture is indicated by signaling a flag and a reference index in a slice header to specify which reference picture list and which reference picture in the reference picture list is used.

To increase the coding efficiency of motion information coding in Inter mode, Skip and Merge modes were proposed and adopted in the HEVC standard to further reduce the data bits required for signaling motion information by inheriting motion information from a spatially neighboring block or a temporal collocated block. For a PU coded in Skip or Merge mode, only an index of a selected final candidate is coded instead of the motion information, as the PU reuses the motion information of the selected final candidate. The motion information reused by the PU includes a motion vector (MV), an inter prediction indicator, and a reference picture index of the selected final candidate. It is noted that if the selected final candidate is a temporal motion candidate, the reference picture index is always set to zero. Prediction residual are coded when the PU is coded in Merge mode, however, the Skip mode further skips signaling of the prediction residual as the residual data of a PU coded in Skip mode is forced to be zero.

A Merge candidate set consists of up to four spatial motion candidates and one temporal motion candidate. As shown in FIG. 1, the first Merge candidate is motion information of a left block A₁ 112, the second Merge candidate is motion information of a top block B₁ 114, the third Merge candidate is motion information of a right above block B₀ 113, and a fourth Merge candidate is motion information of a left below block A₀ 111. Motion information of a left above block B₂ 115 is included in the Merge candidate set to replace a candidate of an unavailable spatial block. A fifth Merge candidate is motion information of a temporal block of first available temporal blocks T_{BR} 121 and T_{CTR} 122. The encoder selects one final candidate from the candidate set for each PU coded in Skip or Merge mode based on MVC such as through a rate-distortion optimization (RDO) decision, and an index representing the selected final candidate is signaled to the decoder. The decoder selects the same final candidate from the candidate set according to the index transmitted in the video bitstream.

A pruning process is performed after deriving the candidate set for Inter, Merge, or Skip mode to check the redundancy among candidates in the candidate set. After removing one or more redundant or unavailable candidates, the size of the candidate set could be dynamically adjusted at both the encoder and decoder sides, and an index for indicating the selected final candidate could be coded using truncated unary binarization to reduce the required data bits. However, although the dynamic size of the candidate set brings coding gain, it also introduces a potential parsing problem. A mismatch of the candidate set derived between the encoder side and the decoder side may occurred when a MV of a previous picture is not decoded correctly and this MV is selected as the temporal motion candidate. A parsing error is thus present in the candidate set and it can propagate severely. The parsing error may propagate to the remaining current picture and even to the subsequent inter coded pictures that allow temporal motion candidates. In order to prevent this kind of parsing error propagation, a fixed candidate set size for Inter mode, Skip mode, or Merge mode is used to decouple the candidate set construction and index parsing at the encoder and decoder sides. In order to compensate the coding loss caused by the fixed candidate set size, additional candidates are assigned to the empty positions in the candidate set after the pruning process. The index for indicating the selected final candidate is coded in truncated unary codes of a maximum length, for example, the maximum length is signaled in a slice header for Skip and Merge modes, and is fixed to 2 for AMVP mode in HEVC.

For a candidate set constructed for a block coded in Inter mode, a zero vector motion candidate is added to fill an empty position in the candidate set after derivation and pruning of two spatial motion candidates and one temporal motion candidate according to the current HEVC standard. As for Skip and Merge modes in HEVC, after derivation and pruning of four spatial motion candidates and one temporal motion candidate, two types of additional candidates are derived and added to fill the empty positions in the candidate set if the number of available candidates is less than the fixed candidate set size. The two types of additional candidates used to fill the candidate set include a combined bi-predictive motion candidate and a zero vector motion candidate. The combined bi-predictive motion candidate is created by combining two original motion candidates already included in the candidate set according to a predefined order. An example of deriving a combined bi-predictive motion candidate for a Merge candidate set is illustrated in FIG. 2. The Merge candidate set 22 in FIG. 2 only has two motion candidates mvL0_A with ref0 in list 0 and mvL1_B with ref0 in list 1 after the pruning process, and these two motion candidates are both uni-predictive motion candidates, the first motion candidate mvL0_A predicts the current block in the current picture 262 from a past picture LOR0 264 (reference picture 0 in List 0) and the second motion candidate mvL1_B predicts the current block in the current picture 262 from a future picture L1R0 266 (reference picture 0 in List 1). The combined bi-predictive motion candidate combines the first and second motion candidates to form a bi-predictive motion vector with a motion vector points to a reference block in each list. The predictor of this combined bi-predictive motion candidate is derived by averaging the two reference blocks pointed by the two motion vectors. The updated candidate set 24 in FIG. 2 includes this combined bi-predictive motion candidate as the third motion candidate (MergeIdx=2). After adding the combined bi-predictive motion candidate in the candidate set for Skip or Merge mode, one or more zero vector motion candidates may be added to the candidate set when there are still one or more empty positions.

Non-Adjacent Merge Candidates A non-adjacent Merge candidate derivation method was proposed to extend locations of spatial motion candidates from neighboring 4×4 blocks of a current block to non-adjacent 4×4 blocks within a left 96 pixels and above 96 pixels range. FIG. 3 illustrates various possible locations of deriving spatial motion candidates for construction of a Merge candidate set, where the locations include adjacent and non-adjacent spatial neighboring blocks. The spatial motion candidates in the Merge candidate set for a current block 30 may be derived from motion information of adjacent spatial 4×4 blocks A, B, C, D, and E, as well as motion information of non-adjacent spatial 4×4 blocks in the left 96 pixels and above 96 pixels range, such as A′, B′, C′, D′, and E′. The non-adjacent Merge candidate derivation method requires more memory to store motion information than the traditional Merge candidate derivation method, for example, motion information of the non-adjacent spatial 4×4 blocks in the left 96 pixels and above 96 pixels range is stored for deriving a non-adjacent Merge candidate.

Subblock Temporal Motion Vector Prediction Sub-block motion compensation is employed in many recently developed coding tools to increase the accuracy of the prediction process. A CU or a PU coded by sub-block motion compensation is divided into multiple sub-blocks, and these sub-blocks within the CU or PU may have different reference pictures and different MVs. Subblock Temporal Motion Vector Prediction (Subblock TMVP, SbTMVP) is a sub-block motion compensation applied to the Merge mode by including at least one SbTMVP candidate as a candidate in the Merge candidate set. A current PU is partitioned into smaller sub-PUs, and corresponding temporal collocated motion vectors of the sub-PUs are searched. An example of the SbTMVP technique is illustrated in FIG. 4, where a current PU 41 of size M×N is divided into (M/P)×(N/Q) sub-PUs, each sub-PU is of size P×Q, where M is divisible by P and N is divisible by Q. The detail algorithm of the SbTMVP mode may be described in three steps as follows.

In step 1, an initial motion vector is assigned for the current PU 41, denoted as vec_init. The initial motion vector is typically the first available candidate among spatial neighboring blocks. For example, List X is the first list for searching collocated information, and vec_init is set to List X MV of the first available spatial neighboring block, where X is 0 or 1. The value of X (0 or 1) depends on which list is better for inheriting motion information, for example, List 0 is the first list for searching when the Picture Order Count (POC) distance between the reference picture and current picture is closer than the POC distance in List 1. List X assignment may be performed at slice level or picture level. After obtaining the initial motion vector, a “collocated picture searching process” begins to find a main collocated picture, denoted as main_colpic, for all sub-PUs in the current PU. The reference picture selected by the first available spatial neighboring block is first searched, after that, all reference pictures of the current picture are searched sequentially. For B-slices, after searching the reference picture selected by the first available spatial neighboring block, the search starts from a first list (List 0 or List 1) reference index 0, then index 1, then index 2, until the last reference picture in the first list, when the reference pictures in the first list are all searched, the reference pictures in a second list are searched one after another. For P-slice, the reference picture selected by the first available spatial neighboring block is first searched; followed by all reference pictures in the list starting from reference index 0, then index 1, then index 2, and so on. During the collocated picture searching process, “availability checking” checks the collocated sub-PU around the center position of the current PU pointed by vec_init scaled is coded by an inter or intra mode for each searched picture. Vec_init_scaled is the MV with appropriated MV scaling from vec_init. Some examples of determining “around the center position” are a center pixel (M/2, N/2) in a PU size M×N, a center pixel in a center sub-PU, or a mix of the center pixel or the center pixel in the center sub-PU depending on the shape of the current PU. The availability checking result is true when the collocated sub-PU around the center position pointed by vec_init_scaled is coded by an inter mode. The current searched picture is recorded as the main collocated picture main_colpic and the collocated picture searching process finishes when the availability checking result for the current searched picture is true. The MV of the around center position is used and scaled for the current block to derive a default MV if the availability checking result is true. If the availability checking result is false, that is when the collocated sub-PU around the center position pointed by vec_init_scaled is coded by an intra mode, it goes to search a next reference picture. MV scaling is needed during the collocated picture searching process when the reference picture of vec_init is not equal to the original reference picture. The MV is scaled depending on temporal distances between the current picture and the reference picture of vec_init and the searched reference picture, respectively. After MV scaling, the scaled MV is denoted as vec_init_scaled.

In step 2, a collocated location in main colpic is located for each sub-PU. For example, corresponding location 421 and location 422 for sub-PU 411 and sub-PU 412 are first located in the temporal collocated picture 42 (main_colpic). The collocated location for a current sub-PU i is calculated in the following:

collocated location x=Sub-PU_i_x+vec_init_scaled_i_x(integer part)+shift_x,

collocated location y=Sub-PU_i_y+vec_init_scaled i_y(integer part)+shift_y,

where Sub-PU_i_x represents a horizontal left-top location of sub-PU i inside the current picture, Sub-PU_i_y represents a vertical left-top location of sub-PU i inside the current picture, vec_init_scaled_i_x represents a horizontal component of the scaled initial motion vector for sub-PU i (vec_init_scaled_i), vec_init_scaled_i_y represents a vertical component of vec_init_scaled_i, and shift_x and shift_y represent a horizontal shift value and a vertical shift value respectively. To reduce the computational complexity, only integer locations of Sub-PU_i_x and Sub-PU_i_y, and integer parts of vec_init_scaled_i_x, and vec_init_scaled_i_y are used in the calculation. In FIG. 4, the collocated location 425 is pointed by vec_init_sub_0 423 from location 421 for sub-PU 411 and the collocated location 426 is pointed by vec_init_sub_1 424 from location 422 for sub-PU 412.

In step 3 of the SbTMVP mode, Motion Information (MI) for each sub-PU, denoted as SubPU_MI_i, is obtained from collocated_picture_i_L0 and collocated_picture_i_L1 on ollocated location x and collocated location y. MI is defined as a set of {MV_x, MV_y, reference lists, reference index, and other merge-mode-sensitive information, such as a local illumination compensation flag}. Moreover, MV_x and MV_y may be scaled according to the temporal distance relation between a collocated picture, current picture, and reference picture of the collocated MV. If MI is not available for some sub_PU, MI of a sub_PU around the center position will be used, or in another word, the default MV will be used. As shown in FIG. 4, subPU0_MV 427 obtained from the collocated location 425 and subPU1_MV 428 obtained from the collocated location 426 are used to derive predictors for sub-PU 411 and sub-PU 412 respectively. Each sub-PU in the current PU 41 derives its own predictor according to the MI obtained on corresponding collocated location.

Spatial-Temporal Motion Vector Prediction In JEM-3.0, a Spatial-Temporal Motion Vector Prediction (STMVP) technique is used to derive a new candidate to be included in a candidate set for Skip or Merge mode. Motion vectors of sub-blocks are derived recursively following a raster scan order using temporal and spatial motion vector predictors. FIG. 5 illustrates an example of one CU with four sub-blocks and its neighboring blocks for deriving a STMVP candidate. The CU in FIG. 5 is 8×8 containing four 4×4 sub-blocks, A, B, C and D, and neighboring N×N blocks in the current picture are labeled as a, b, c, and d. The STMVP candidate derivation for sub-block A starts by identifying its two spatial neighboring blocks. The first neighboring block c is a N×N block above sub block A, and the second neighboring block b is a N×N block to the left of the sub-block A. Other N×N block above sub-block A, from left to right, starting at block c, are checked if block c is unavailable or block c is intra coded. Other N×N block to the left of sub-block A, from top to bottom, starting at block b, are checked if block b is unavailable or block b is intra coded. Motion information obtained from the two neighboring blocks for each list are scaled to a first reference picture for a given list. A Temporal Motion Vector Predictor (TMVP) of sub-block A is then derived by following the same procedure of TMVP derivation as specified in the HEVC standard. Motion information of a collocated block at location D is fetched and scaled accordingly. Finally, all available motion vectors are averaged separately for each reference list. The averaged motion vector is assigned as the motion vector of the current sub-block.

Affine MCP Affine Motion Compensation Prediction (Affine MCP) is a technique developed for predicting various types of motion other than the translation motion. For example, rotation, zoom in, zoom out, perspective motions and other irregular motions. An exemplary simplified affine transform MCP as shown in FIG. 6A is applied in Joint Exploration test Model 3.0 (JEM-3.0) software to improve the coding efficiency. An affine motion field of a current block 61 is described by motion vectors 613 and 614 of two control points 611 and 612. The Motion Vector Field (MVF) of a block is described by the following equations:

$$\{ \begin{matrix}{v}_{x} = \frac{( {v}_{1 x} - {v}_{0 x} )}{w} x - \frac{( {v}_{1 y} - {v}_{0 y} )}{w} y + {v}_{0 x} \\ {v}_{y} = \frac{( {v}_{1 y} - {v}_{0 y} )}{w} x + \frac{( {v}_{1 x} - {v}_{0 x} )}{w} y + {v}_{0 y}\end{matrix}$$

Where (v₀ₓ, v_{0y}) represents the motion vector 613 of the top-left corner control point 611, and (v₁ₓ, v_{1y}) represents the motion vector 614 of the top-right corner control point 612.

A block based affine transform prediction is applied instead of pixel based affine transform prediction in order to further simplify the affine motion compensation prediction. FIG. 6B illustrates partitioning a current block 62 into sub-blocks and affine MCP is applied to each sub-block. As shown in FIG. 6B, a motion vector of a center sample of each 4×4 sub-block is calculated according to the above equation in which (v₀ₓ, v_{0y}) represents the motion vector 623 of the top-left corner control point 621, and (v₁ₓ, v_{1y}) represents the motion vector 624 of the top-right corner control point 622, and then rounded to 1/16 fraction accuracy. Motion compensation interpolation is applied to generate a predictor for each sub-block according to the derived motion vector. After performing motion compensation prediction, the high accuracy motion vector of each sub-block is rounded and stored with the same accuracy as a normal motion vector.

Affine MCP may be applied to a block coded in Merge mode or AMVP mode by selecting a candidate from a candidate set corresponding to an affine coded neighboring block or selecting an affine candidate from the candidate set. The block is then coded in affine MCP by inheriting affine parameters of the selected affine coded neighboring block or the affine candidate. For example, a block above a current block is coded by affine MCP and the current block is coded by Merge mode. Spatial neighboring blocks B₁ and B₀ of the current block as shown in FIG. 1 are affine coded blocks while other spatial neighboring blocks A₁, A₀ and temporal block T_{BR} are tradition inter prediction coded blocks in this example. The affine coded blocks can be coded by affine Merge mode or affine AVMP mode, and the tradition inter prediction coded blocks can be coded by regular Merge mode or regular AVMP mode. Affine parameters of one or more previously coded blocks may be stored and used to generate one or more affine candidates.

### BRIEF SUMMARY OF THE INVENTION

Methods of video processing in a video coding system utilizing a motion vector predictor (MVP) for coding a current motion vector (MV) of a current block coded in inter picture prediction such as Inter, Merge, or Skip mode, comprise receiving input data associated with the current block in a current picture, including one or more motion candidates in a current candidate set for the current block, deriving an average candidate from MVs of two or more neighboring blocks of the current block, including the average candidate in the current candidate set, determining one selected candidate from the current candidate set as a MVP for the current MV, and encoding or decoding the current block in inter picture prediction utilizing the MVP. At least one neighboring block used to derive the average candidate is a temporal block in a temporal collocated picture. Each motion candidate or average candidate in the current candidate includes one MV pointing to a reference picture associated with list 0 or list 1 for uni-prediction or two MVs pointing to a reference picture associated with list 0 and a reference picture associated with list 1 for bi-prediction.

In some embodiments, each of the neighboring blocks is a spatial neighboring block of the current block in the current picture or a temporal block in the temporal collocated picture. The spatial neighboring block is either an adjacent neighboring block or a non-adjacent neighboring block of the current block. The average candidate is derived from the motion information of one temporal block and two spatial neighboring blocks according to an embodiment. In other embodiments, the average candidate is derived from the motion information of one temporal block and one spatial neighboring block, motion information of two temporal blocks and one spatial neighboring block, motion information of three temporal blocks and one spatial neighboring block, motion information of two temporal blocks and two spatial neighboring blocks, motion information of one temporal block and three spatial neighboring blocks, or motion information of three temporal blocks and one spatial neighboring block.

The video processing method may further comprise checking if any of the motion information of the neighboring blocks for deriving the average candidate is unavailable. In some embodiments, when any of the motion information of the neighboring blocks is unavailable, a replacement block is determined to replace the neighboring block with unavailable motion information. A modified average candidate is derived using the replacement block and other neighboring block with available motion information to replace the average candidate. The replacement block is a predefined temporal block, a temporal block collocated to the neighboring block with unavailable motion information, a predefined adjacent spatial neighboring block, or a predefined non-adjacent spatial neighboring block if the neighboring block with unavailable motion information is a spatial neighboring block. In another embodiment, when any of the motion information of the neighboring blocks is unavailable, the average candidate is set as unavailable and excluded from the current candidate set. In yet another embodiment, when any of the motion information is unavailable, a modified average candidate is derived using only the rest available motion information of the neighboring blocks, and the modified average candidate replaces the average candidate to be included in the current candidate set. Since the modified average candidate may not be as reliable, a position of the modified average candidate in the current candidate set may be moved backward in comparison to a predefined position for the average candidate.

In some embodiments, motion information of at least one neighboring block used to derive the average candidate is not one of the motion candidate(s) already included in the current candidate se, for example, all the motion information for deriving the average candidate are not the same as any motion candidate already existed in the current candidate set. In some embodiments, one or more motion candidates already included in the current candidate set are used to derive the average candidate. The motion candidate already included in the current candidate set is limited to a spatial motion candidate according to one embodiment.

Two or more average candidates may be included in the current candidate set according to some exemplary embodiments, and the average candidates are inserted in the current candidate set in adjacent positions or non-adjacent positions.

In one embodiment, reference picture indexes of all the neighboring blocks for deriving the average candidate equal to a given reference picture index as MVs of all the neighboring blocks are pointing to the given reference picture. The given reference picture index of the given reference picture is predefined, explicitly transmitted in a video bitstream, or implicitly derived from the motion information of the neighboring block for generating the average candidate. In another embodiment, the average candidate is derived from one or more scaled MVs, and each scaled MV is computed by scaling one MV of the neighboring block to the given reference picture. A number of scaled MVs used to derive the average candidate may be constraint by a total scaling count. In another embodiment, the average candidate is derived by directly averaging MVs of the neighboring blocks without scaling regardless reference picture indexes of the neighboring blocks are same or different. In yet another embodiment, the average candidate is directly derived using one of the neighboring blocks without averaging if reference picture indexes or Picture Order Count (PoC) of the neighboring blocks are different.

The video processing method may be simplified to reduce the computational complexity. In one embodiment, the video processing method is simplified by averaging only one of horizontal and vertical components of the motion information of the neighboring blocks, and the other component of the average candidate is directly set to the other component of one of the motion information of the neighboring blocks. In another embodiment, the video processing method is simplified by averaging only one list MV of the neighboring blocks, and directly setting the other list MV of the average candidate as a MV of one neighboring block in the other list.

In some embodiments, a pruning process is performed to compare the average candidate with one or more motion candidates already existed in the current candidate set, and remove the average candidate from the current candidate set or not including the average candidate in the current candidate set if the average candidate is identical to one motion candidate. The pruning process may be a full pruning process or partial pruning process. In one embodiment, the average candidate is only compared with partial or all of the motion candidates in the current candidate set used to derive the average candidate, and in another embodiment, the average candidate is only compared with partial or all of the motion candidates in the current candidate set not used to derive the average candidate.

An embodiment of the video processing method derives an average candidate by weighted averaging MVs of the neighboring blocks. The current candidate set may be shared by sub-blocks in the current block if the current block is coded in a sub-block mode.

Aspects of the disclosure further provide an apparatus for video processing in a video coding system utilizing a MVP for coding a current MV of a current block coded in Inter picture prediction. The apparatus comprises one or more electronic circuits configured for receiving input data of the current block in a current picture, deriving motion candidates and including the motion candidates in a current candidate set for the current block, deriving an average candidate from motion information of a predetermined set of neighboring blocks of the current block, including the average candidate in the current candidate set, determining one selected candidate as a MVP for the current MV from the current candidate set, and encoding or decoding the current block in inter picture prediction utilizing the MVP. At least one neighboring block used to derive the average candidate is a temporal block in a temporal collocated picture.

Aspects of the disclosure further provide a non-transitory computer readable medium storing program instructions for causing a processing circuit of an apparatus to perform a video processing method to encode or decode a current block utilizing a MVP selected from a current candidate set, where the current candidate set includes one or more average candidate. The average candidate is derived from motion information of a predetermined set of neighboring blocks and at least one of the neighboring blocks is a temporal block in a temporal collocated picture. Other aspects and features of the invention will become apparent to those with ordinary skill in the art upon review of the following descriptions of specific embodiments.

### BRIEF DESCRIPTION OF THE DRAWINGS

Various embodiments of this disclosure that are proposed as examples will be described in detail with reference to the following figures, and wherein:

FIG. 1 illustrates locations of spatial candidates and temporal candidates for constructing a candidate set for Inter mode, Skip mode, or Merge mode defined in the HEVC standard.

FIG. 2 illustrates an example of deriving a combined bi-predictive motion candidate from two existing uni-directional motion candidates already existed in a candidate set.

FIG. 3 illustrates locations of some adjacent and non-adjacent Merge candidates for construction of a Merge candidate set for a current block.

FIG. 4 illustrates an example of determining sub-block motion vectors for sub-blocks of a current PU according to the SbTMVP coding tool.

FIG. 5 illustrates an example of determining a Merge candidate for a CU split into four sub-blocks according to the STMVP coding tool.

FIG. 6A illustrates an exemplary simplified affine transform motion compensation prediction applied in JEM-3.0.

FIG. 6B illustrates an exemplary sub-block affine transform motion compensation prediction.

FIG. 7A illustrates exemplary adjacent spatial neighboring blocks of a current block for deriving an average candidate for the current block according to some embodiments of the present invention.

FIG. 7B illustrates exemplary temporal blocks in a temporal collocated reference picture for deriving an average candidate for the current block according to some embodiments of the present invention.

FIG. 8 illustrates exemplary adjacent and non-adjacent spatial neighboring blocks of a current block for deriving an average candidate for the current block according to some embodiment of the present invention.

FIG. 9 is a flowchart illustrating an embodiment of the video coding system for processing a current block coded in AMVP, Merge, Skip or Direct mode by deriving an average candidate from motion information of neighboring blocks.

FIG. 10 illustrates an exemplary system block diagram for a video encoding system incorporating the video processing method according to embodiments of the present invention.

FIG. 11 illustrates an exemplary system block diagram for a video decoding system incorporating the video processing method according to embodiments of the present invention.

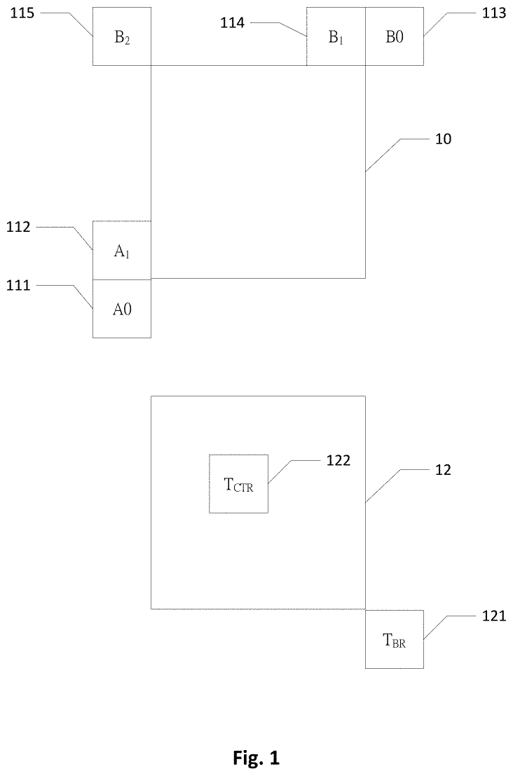

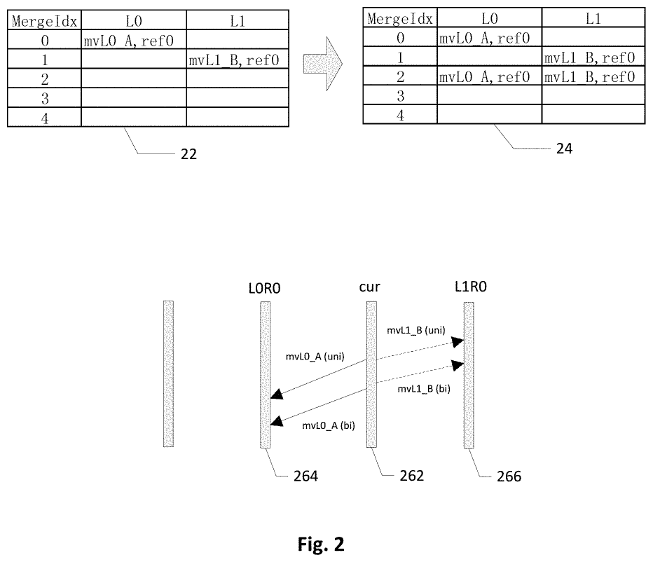

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of generating one or more average candidates for a current block coded in inter picture prediction, as represented in the figures, is not intended to limit the scope of the invention, as claimed, but is merely representative of selected embodiments of the invention.

Embodiments of the present invention provide new methods of generating one or more average candidates to be added to a candidate set for encoding or decoding a current block coded in inter picture prediction. The current block is a PU, a leaf CU, or a sub-block in various different embodiments. In the following, a candidate set is used to represent an AMVP candidate set or a Merge candidate set, which is constructed for encoding or decoding a block coded in inter picture prediction such as AMVP mode (i.e. Inter mode), Merge mode, Skip mode, or Direct mode. One or more average candidates of the present invention may be included in the candidate set according to a predefined order. There may be one or more duplicated candidates in the candidate set, and a pruning process may be performed in some embodiments to remove one or more redundant candidates in the candidate set. The average candidate derived using an embodiment of the present invention may be inserted in the candidate set before or after the pruning process. For example, an average candidate is added to an empty position of a Merge candidate set after pruning of four spatial motion candidates and one temporal motion candidate. Another average candidate or a zero vector motion candidate may be added to the Merge candidate set if the Merge candidate set is not full after adding the first average candidate. One final candidate is selected from the candidate set as a Motion Vector Predictor (MVP) by Motion Vector Competition (MVC) such as a Rate Distortion Optimization (RDO) decision at the encoder side or by an index transmitted in a video bitstream at the decoder side, and the current block is encoded or decoded by deriving a predictor according to motion information of the MVP. A MV difference (MVD) between the MVP and a current MV respectively along with an index indicating the MVP and prediction residual of the current block are signaled for the current block coded in Inter mode. An index indicating the MVP along with the prediction residual of the current block is signaled for the current block coded in Merge mode, and only the index indicating the MVP is signaled for the current block coded in Skip mode.

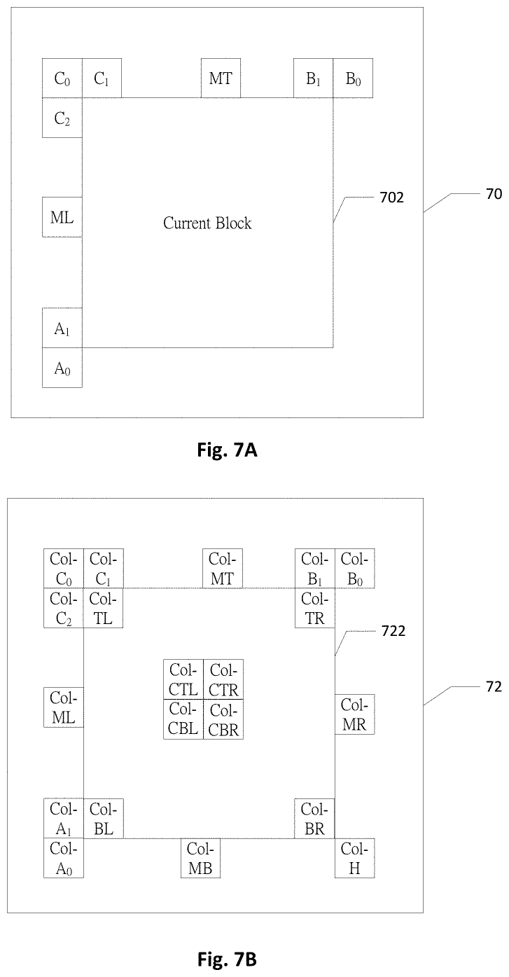

Average Candidate Derivation Methods In some exemplary embodiments of the present invention, a current candidate set for coding a current block includes an average candidate, and the average candidate is generated by averaging MVs of a predetermined set of neighboring blocks. Each of the neighboring blocks for deriving the average candidate is either a spatial neighboring block or a temporal neighboring block, where at least one of the neighboring blocks is a temporal block in a temporal collocated picture. FIG. 7A illustrates some examples of spatial neighboring blocks of a current block 702 in a current picture 70 that could be used for deriving an average candidate according to some embodiments of the present invention. In this embodiment, an average candidate for the current block 702 is generated by motion information of one or more of the spatial neighboring block as shown in FIG. 7A. The spatial neighboring blocks include neighboring blocks A₀, A₁, ML, and C₂ at the left hand side of the current block 702, neighboring blocks B₀, B₁, MT, and C₁ above the current block 702, and neighboring block C₀ adjacent to the top-left corner of the current block 702. An embodiment of constructing a Merge candidate set for a current block includes spatial motion candidates of neighboring blocks A₁, B₁, B₀, and A₀, a temporal candidate of T_{BR}, and an average candidate in the Merge candidate set. The average candidate is derived by averaging MVs of a predetermined set of neighboring blocks, and embodiments of the predetermined set of neighboring blocks contain at least a temporal block in a temporal collocated picture.

In one embodiment, when the Merge candidate set already contains motion candidates of neighboring block A₁, B₁, B₀, and A₀, at least one of the neighboring blocks for deriving the average candidate is not any of the neighboring blocks A₁, B₁, B₀, and A₀, and T_{BR}. An exemplary average candidate is derived from motion information of neighboring blocks A₀, B₀ and C₀, and another exemplary average candidate is derived from motion information of neighboring blocks ML, MT, C₀ and T_{CTR}.

FIG. 7B illustrates some examples of temporal neighboring blocks of a current block 702 that could be used for generating an average candidate for the current block according to some embodiments of the present invention. The temporal neighboring blocks as shown in FIG. 7B include four temporal blocks Col-CTL, Col-CTR, Col-CBL, and Col-CBR in the center of a collocated block 722 of the current block 702, four temporal blocks Col-TL, Col-TR, Col-BL, and Col-BR at four corners of the collocated block 722, and twelve temporal blocks Col-A₀, Col-A₁, Col-ML, Col-C₂, Col-C₀, Col-C₁, Col-MT, Col-B₁, Col-B₀, Col-MR, Col-H, and Col-MB adjacent to a boundary of the collocated block 722 or adjacent to a corner of the collocated block 722. The temporal neighboring blocks shown in FIG. 7B are located in a temporal collocated picture 72. An exemplary average candidate is derived by averaging MVs of two temporal blocks Col-TL and Col-H, and another exemplary average candidate is derived by averaging MVs of two temporal blocks Col-CBL and Col-A₁ and one spatial neighboring block A₁.

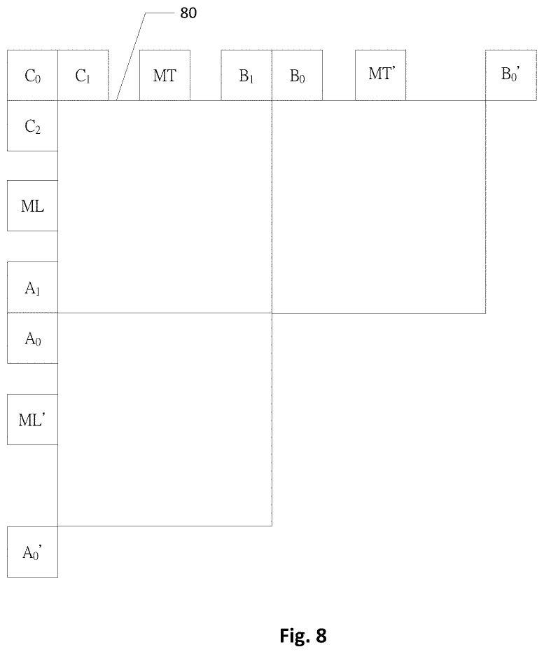

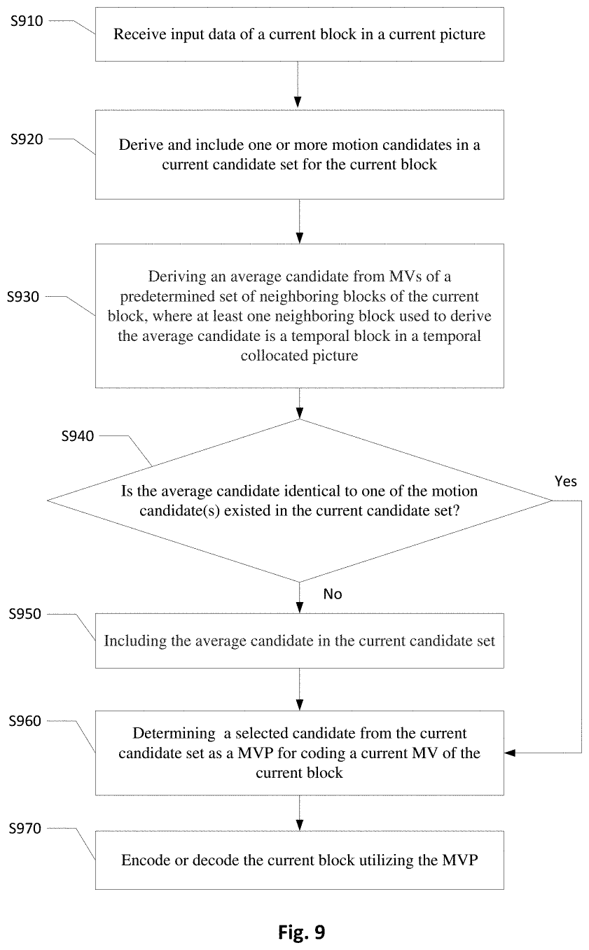

In some embodiments, the neighboring blocks for generating the average candidate also include one or more non-adjacent spatial neighboring blocks. FIG. 8 illustrates some examples of the non-adjacent spatial neighboring blocks of a current block 80 that could be used to derive an average candidate according to some embodiment of the present invention. The non-adjacent spatial neighboring blocks may include ML′, A₀′, MT′, and B₀′, where a vertical displacement between the non-adjacent spatial neighboring block ML′ and the corresponding spatial neighboring block ML and a vertical displacement between the non-adjacent spatial neighboring block A₀′ and the corresponding spatial neighboring block A₀ equal to the CU height of the current block 80.l A horizontal displacement between the non-adjacent spatial neighboring block MT′ and the corresponding spatial neighboring block MT and a horizontal displacement between the non-adjacent spatial neighboring block B₀′ and the corresponding spatial neighboring block B₀ equal to the CU width of the current block 80. An exemplary average candidate is derived from averaging MVs of non-adjacent spatial neighboring blocks ML′ and MT′, and another exemplary average candidate is derived from averaging MVs of adjacent spatial neighboring blocks A₀ and B₀ and non-adjacent spatial neighboring blocks A₀′ and B₀′.

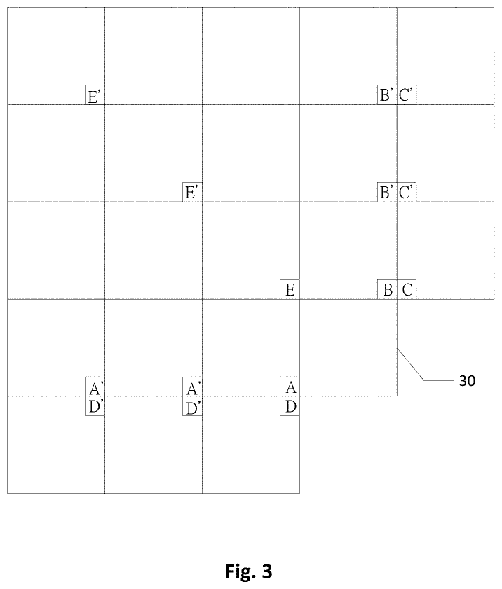

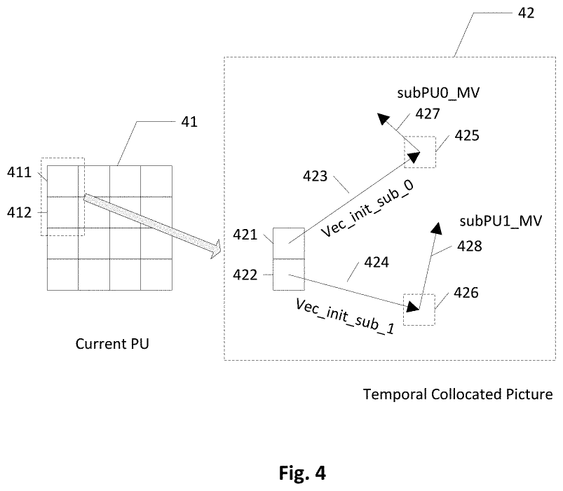

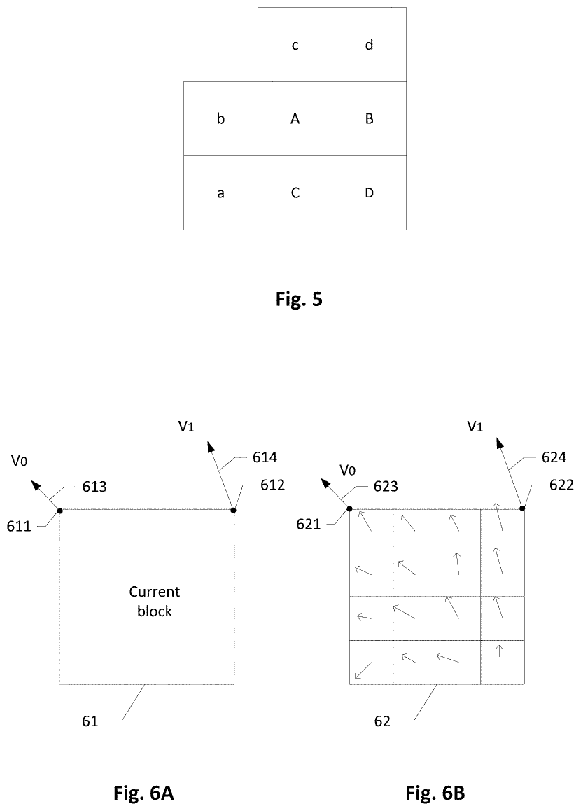

In one embodiment, motion information of one temporal block and three spatial neighboring blocks are averaged to generate an average candidate for coding a current block. The spatial neighboring blocks may be any of the neighboring blocks as shown in FIG. 7A or any of the non-adjacent spatial neighboring blocks as illustrated in FIG. 3 or FIG. 8. For example, MVs of the neighboring blocks {A₀, B₀, C₀, Col-X}, {A₁, B₁, C₀, Col-X}, or {C₀, MT, ML, Col-X} are averaged. Col-X is a temporal block in a collocated reference picture, and the temporal block may be inside or adjacent to a boundary or corner of a collocated block, some examples of the temporal block Col-X are demonstrated in FIG. 7B. In some embodiments, if motion information of the temporal block is unavailable, motion information of another temporal block is used to generate the average candidate instead, or there may be a predefined sequence of temporal blocks, motion information of a temporal block in the predefined sequence is used to replace the unavailable motion information if motion information of its prior temporal block(s) in the predefined sequence is unavailable. For example, motion information of Col-CBR, Col-CTL, Col-TR, Col-BR, Col-BL, or Col-TL is used to replace the unavailable motion information of the predefined temporal block. In another example, the predefined sequence contains Col-CBR, Col-CTL, and Col-BR, where Col-CBR is used if the predefined temporal block is not coded in Inter picture prediction, Col-CTL is used if Col-CBR is not coded in Inter picture prediction, and Col-BR is used if Col-CTL is not coded in Inter picture prediction. The average candidate is utilized in the Merge candidate set or AMVP MVP candidate set construction for encoding or decoding the current block.

In some embodiments, motion information of one temporal block and two spatial neighboring blocks of a current block are averaged to generate an average candidate for constructing a candidate set of the current block. For example, MVs of the neighboring blocks {MT, ML, Col-X}, {MT′, ML′, Col-X}, {B₁, A₁, Col-X}, {B₀, A₀, Col-X}, or {B₀′, A₀′, Col-X} are averaged to generate an average candidate. When generating an average candidate from three MVs, it is easier to implement dividing by four rather than dividing by three, in order to simplify the calculations, an embodiment adjusts the weighting factors before averaging to avoid complex calculations. For example, the weighting factor for the MV of the temporal block is two while the weighting factor for the MVs of the spatial neighboring blocks is one; in that case, the average candidate is calculated by shifting the sum of the weighted MV of the temporal block and the weighted MVs of the spatial blocks by two bits. In this example, it is equivalent to compute an average candidate from MVs of neighboring blocks {MT, ML, Col-X, Col-X}, {MT′, ML′, Col-X, Col-X }, {B₁, A₁, Col-X, Col-X }, {B₀, A₀, Col-X, Col-X }, or {B₀′, A₀′, Col-X, Col-X }.

In yet another embodiment, motion information of one temporal block and one spatial neighboring block of a current block are averaged to generate an average candidate for constructing a candidate set of the current block. Some examples of the temporal block and spatial neighboring block pair are {Col-X, B₀}, {Col-X, B₁}, {Col-X, MT}, {Col-X, C₀}, {Col-X, C₁}, {Col-X, C₂}, {Col-X, ML}, {Col-X, A1}, and {Col-X, A₀}. One or more average candidates generated by the motion information of the exemplary pair are used for Merge candidate set or AMVP MVP candidate set generation. For example, a first average candidate generated from motion information of {Col-H, MT} and a second average candidate generated from motion information of {Col-H, ML} are both included in the Merge candidate set or AMVP MVP candidate set for encoding or decoding a current block.

In general, a predefined number of temporal blocks and a predefined number of spatial neighboring blocks are used to derive one or more average candidates for candidate set construction. For example, an average candidate is derived from motion information of two temporal blocks and motion information of one spatial neighboring block, an average candidate is derived from motion information of three temporal blocks and motion information of one spatial neighboring block, or an average candidate is derived from motion information of two temporal blocks and motion information of two spatial neighboring blocks. Alternatively, one temporal block and three spatial neighboring blocks of a current block may be used to generate an average candidate for the current block, or three temporal blocks and one spatial neighboring block of a current block may be used to generate an average candidate for the current block.

Modified Average Candidate A predetermined set of neighboring blocks used to generate an average candidate may contain one or more neighboring blocks with unavailable motion information, for example, one neighboring block in the predetermined set is coded in Intra mode so there is no motion information associated with this neighboring block. In some embodiments, the video encoder or decoder checks if any of the MVs for generating an average candidate is unavailable before generating the average candidate, and if a MV of a neighboring block for deriving the average candidate is unavailable, a replacement block is used to replace this neighboring block to derive a modified average candidate. If motion information of a spatial neighboring block for deriving an average candidate is unavailable, according to some embodiments, a predefined temporal block or a temporal block collocated to the spatial neighboring block is selected as a replacement block to replace the spatial neighboring block to generate a modified average candidate. For example, an average candidate is meant to be generated by MVs of two spatial neighboring blocks and one temporal block, and if the MV of a first spatial neighboring block is unavailable, the MV of the same temporal block or a MV of a another temporal block is used to replace the unavailable MV associated with the first spatial neighboring block. The MV of the temporal block collocated to the first spatial neighboring block may be used to replace the unavailable MV, for example the MV of Col-ML is used to replace the unavailable MV for generating a modified average candidate when the MV of the spatial neighboring block ML is unavailable. According to some other embodiments, the MV of a predefined spatial neighboring block, such as a spatial neighboring block B₀, B₁, MT′, B₀′, A₀, A₁, ML′, or A₀′ or a predefined non-adjacent spatial block as shown in FIG. 8, is used to replace the neighboring block with an unavailable MV.

In some other embodiments, when the checking result shows there is at least one MV for generating an average candidate is unavailable, no additional MV is used to replace the unavailable MV, in one embodiment, the average candidate is set as unavailable so it is not generated or not included in the candidate set, in another embodiment, a modified average candidate is generated by averaging the rest available MVs.

An embodiment of generating a modified average candidate to replace an average candidate further changes a position of the modified average candidate in the candidate set. In cases when at least one of the MVs for generating the average candidate is unavailable and a modified average candidate is derived by rest available MVs or by replacing each unavailable MV with a MV of a replacement block, the modified average candidate is inserted in a different position in the candidate set comparing to the regular average candidate. Since the modified average candidate is less reliable comparing to the regular average candidate, the position of the modified average candidate may be moved backward in the candidate set in comparison to a predefined position for the average candidate. For example, if all MVs for generating an average candidate are available, the average candidate is inserted in a position before the temporal collocated candidate, if at least one MV for generating the average candidate is unavailable, the modified average candidate is inserted in a position after the temporal collocated candidate.

MVs Already In Candidate Set According to various embodiments of the present invention, an average candidate to be included in a current candidate set is derived from motion information of a predetermined set of neighboring blocks of a current block, and at least one neighboring block is a temporal block in a temporal collocated picture. In some embodiments, one or more motion candidates already in the current candidate set for coding the current block are used for generating the average candidate. The one or more motion candidates already in the candidate set include one or more spatial candidates and/or one or more temporal candidates. For example, an average candidate at a predefined position, such as before the ATMVP candidate, after the ATMVP candidate, or before the temporal MV candidate, is generated by one temporal MV not in the candidate set and one or more motion candidates already in the candidate set. The one or more motion candidates already in the candidate set used for generating the average candidate can be limited to spatial candidates in the candidate set in one embodiment. For example, an average candidate at a predefined position is derived by averaging a temporal MV not in the candidate set and the first two spatial motion candidates already existed in the candidate set.

In one embodiment, to generate an average candidate from two or more motion candidates already in a candidate set, if there is only one available motion candidate in the candidate set, the average candidate is not added to the candidate set. In another embodiment, if there is only one available motion candidate in the candidate set and the available motion candidate is a spatial candidate, the average candidate supposed to be derived from two or more motion candidates is not added into the candidate set. In yet another embodiment, if there is only one available motion candidate in the candidate set and the motion candidate is a temporal candidate, the average candidate supposed to be derived from two or more motion candidates already in the candidate set is not added into the candidate set.

Position of Average Candidate in Candidate Set Each average candidate derived according to one of the various embodiments of the present invention is inserted in a predefined position in the Merge candidate set or AMVP candidate set. For example, a predefined position may be a first candidate position, a position before the temporal collocated candidate, a position before the spatial motion candidate C₀, a position after the spatial motion candidate A₁, a position after the spatial motion candidate B₁, a position after the candidate B₀, a position after the spatial motion candidate A₀, a position before the ATMVP candidate, a position after the ATMVP candidate, a position after the spatial motion candidate C₀. In one embodiment, two or more average candidates derived from motion information of different sets of neighboring blocks are inserted in the candidate set and these average candidates are put together, for example, two average candidates are inserted in the N^{th} position and the N+1^{th} position in the candidate set, in another embodiment, these average candidates are put in non-adjacent positions.

Constraint MVs Pointing to Target Reference Picture In one embodiment, only the MVs pointing to a given target reference picture are used to derive an average candidate. The average candidate is derived as a mean MV of the MVs pointing to the given target reference picture, and a given target reference picture index is either predefined, explicitly transmitted in a video bitstream, or implicitly derived from MVs for generating the average candidate. An example of implicitly deriving a target reference picture index first identifies reference picture indexes of neighboring blocks and then calculates a majority, minimum, or maximum of the reference picture indexes of these neighboring blocks as the target reference picture index. An example of a predefined target reference picture index is reference picture index 0 in the given reference list.

In one embodiment of deriving an average candidate, the average candidate for list 0 or list 1 is derived as the mean MV of limited list 0 or list 1 MVs, where the limited list 0 or list 1 MVs are MVs pointing to a given target reference picture. In other words, only the MVs with the same reference picture index as the given target reference picture are averaged for deriving the average candidate. According to an embodiment of deriving an average candidate from limited MVs pointing to a given target reference picture, the average candidate is derived only if any MV of a predetermined set of neighboring blocks points to the given target reference picture in at least one list or both lists, otherwise the average candidate is not derived.

Deriving Average Candidate from MVs Pointing to Different Reference Pictures In the following embodiments, an average candidate may be derived when MVs of a predetermined set of neighboring blocks are pointing to different reference pictures. In one embodiment of deriving an average candidate from MVs of a predetermined set of neighboring blocks, any MV not pointing to a given target reference picture is scaled to the given target reference picture, and the average candidate is derived as the mean MV of all scaled or un-scaled MVs pointing to the given target reference picture. For example, the list 0 MV of an average candidate is derived by first scaling all MVs of the predetermined set of neighboring blocks to a target reference picture in list 0 and then averaging the scaled list 0 MVs. A target reference picture index of the target reference picture for a reference list is predefined, explicitly transmitted in a video bitstream, or implicitly derived from MVs of the predetermined set of neighboring blocks. For example, the target reference picture index of a reference list is derived as a majority, minimum, or maximum of reference picture indexes of the predetermined set of neighboring blocks associated with the reference list. In this embodiment, all MVs not pointing to the target reference picture in the reference list are scaled to the target reference picture and then averaged with all MVs originally pointing to the target reference picture to derive the average candidate. In one embodiment of deriving a list 0 MV of an average candidate, if any neighboring block in the predetermined set of neighboring blocks has no MV in list 0, the MV of list 1 is scaled to a target reference picture of list 0, and the scaled MV is used to generate the list 0 MV of the average candidate. Alternatively, if list 1 MV of any neighboring block in the predetermined set of neighboring blocks is unavailable, list 0 MV is scaled to a target reference picture of list 1 for deriving the list 1 MV of the average candidate.

In one embodiment, a total scaling count is used to constraint a number of scaled MVs used to derived an average candidate, for example, at most zero MV, one MV, or two MVs of a predetermined set of neighboring blocks can be scaled for generating the average candidate. In this embodiment of applying a total scaling count, an average candidate is derived from partial scaled input MVs or un-scaled input MVs. In a case of constraining the total scaling count to zero, an average candidate is derived by directly averaging all input MVs of a predetermined set of neighboring blocks without scaling, even if the MVs of the predetermined set of neighboring blocks are pointing to different reference pictures. The reference picture index of the average candidate may be set to one of the reference indexes of the predetermined set of neighboring blocks. In a case of constraining the total scaling count to one, if there are more than 1 input MV pointing to a reference picture different from a given target reference picture, the average candidate is derived by a scaled MV and at least one un-scaled MV.

In another embodiment, for generating a MV of an average candidate for a current block from a predetermined set of neighboring blocks of the current block, if reference indexes or PoC (Picture order Count) of the predetermined set of neighboring blocks are different, one of the reference indexes and the associated MV is directly used as the average candidate without averaging. For example, the reference index and MV of a neighboring block in the predetermined set of neighboring block with a smallest reference index is selected, and in another example, the reference index and MV of a neighboring block in the predetermined set of neighboring blocks with a largest reference index is selected. The MV averaging process for reference list 0 and reference list 1 may be separately performed, and different reference lists may adopt different selection behaviors, for example, for list 0 of an average candidate, the MV and reference index of a neighboring block in the predetermined set of neighboring blocks with a smallest reference index are selected. For list 1 of the average candidate, the MV and reference index of a neighboring block in the predetermined set of neighboring blocks with a largest reference index are selected. In another example, the MV and reference index of a neighboring block in the predetermined set of neighboring blocks with a largest reference index are selected for list 0 of an average candidate, while the MV and reference index of a neighboring block with a smallest reference index are selected for list 1 of the average candidate. If one neighboring block in the predetermined set of neighboring blocks is uni-predicted with only MV in a first list, the MV of the average candidate in a second list may be set to zero vector according to one embodiment, or the MV of the average candidate in the second list is derived by averaging a zero vector with second list MVs of other neighboring blocks in the predetermined set of neighboring blocks according to another embodiment. For example, a uni-predicted neighboring block does not have a list 1 MV, a zero vector may be directly used as the list 1 MV of the average candidate, or a zero vector may be averaged with the list 1 MV(s) of other neighboring block(s) in the predetermined set of neighboring blocks to derive the list 1 MV of the average candidate.

Adaptively Deriving Average Candidate In some embodiments, an average candidate for a current block is adaptively derived according to motion information of a predetermined set of neighboring blocks of the current block. For example, if any MV of the neighboring blocks in the predetermined set points to a given target reference picture in at least one list or both lists, the average candidate is derived by motion information of the predetermined set of neighboring blocks, otherwise, the average candidate is not derived from motion information of the predetermined set of neighboring blocks. In another embodiment, an average candidate is only derived when all MVs of the predetermine set of neighboring blocks are pointing to the same reference picture.

Reducing Complexity A MV describes the transformation from one two-dimensional video picture to another two-dimensional video picture, which is measured in two directions. A MV of a current block includes a horizontal component and a vertical component, representing the two-dimensional displacement between the current block and its corresponding reference block. To simplify the derivation process of an average candidate, some embodiments only average MVs in one dimension. For example, a horizontal component of an average candidate for a current block is computed by averaging the horizontal component of MVs associated with a predetermined set of neighboring blocks of the current block, while a vertical component of the average candidate is directly set to the vertical component of one of the MVs associated with the predetermined set of neighboring blocks. In another embodiment of complexity reduction for the average candidate derivation process, only the MV in a first list (i.e. list 0 or list 1) is calculated by averaging multiple first list MVs associated with a predetermined set of neighboring blocks, while the MV in a second list (i.e. list 1 or list 0) is directly set to the second list MV of one neighboring block in the predetermined set. The complexity of the average candidate derivation process is also reduced by setting a total scaling count to zero or one as mentioned in one of the previous paragraphs.

Rounding Mechanism The average process for deriving an average candidate from MVs associated with a predetermined set of neighboring blocks may be implemented using one of the conventional rounding mechanism, for example, “rounding half up”, “rounding half down”, “rounding toward zero”, “rounding away from zero”, and any other means to replace the average value with another representation to fit in the limited bit-depth representation.

Redundancy Check The one or more average candidates generated according to an embodiment of the present invention may be compared to one or more motion candidates already existed in the candidate set for redundancy check. After the redundancy check, the average candidate will not be added to the candidate set if it is identical to one of the motion candidates. This pruning process may improve the coding efficiency by removing one or more redundant candidates from the candidate set. A full pruning process may be performed to remove every single redundant candidate from the candidate set by comparing each pair of candidates in the candidate set. To reduce the candidate set construction complexity, a partial pruning process may be performed. In some embodiments of the partial pruning process, an average candidate derived by one or more motion candidates already existed in the candidate set is only compared with partial or all motion candidate(s) used to generate the average candidate for redundancy check, alternatively, the average candidate is only compared with partial or all motion candidate(s) not used to generate this average candidate. For example, candidate-A, candidate-B, and candidate-C already existed in a candidate set are used to generate an average candidate along with one or more MVs not in the candidate set, and this newly generated average candidate is only compared with candidate-A, candidate-B, or candidate-C, or compared with both candidate-A and candidate-B, both candidate-B and candidate-C, or both candidate-A and candidate-C, or compared with all three input candidates candidate-A, candidate-B, and candidate-C. In another example, before generating the average candidate, the candidate set includes candidate-A, candidate B, candidate-C, candidate-D, -and candidate-E, and this newly generated average candidate is only compared with candidate-C or candidate-D, or both candidate-C and candidate-D for redundancy check.

In some embodiments, an average candidate is compared with partial candidates in the candidate set for redundancy check. For example, the average candidate is compared with the first one, two, or three candidates already existed in the candidate set, and if the average candidate is the same as a candidate already existed in the candidate set, this average candidate is not inserted into the candidate set.

In one embodiment, if there are more than one average candidate to be inserted in the candidate set, only the first one, two, or three average candidates are compared with the candidates already in the candidate set, the pruning process is not performed for the rest average candidates as the rest average candidates are added into the candidate set directly without pruning. In another embodiment, the average candidates are pruned with each other and not pruned with the candidate already existed in the candidate set. For example, a third average candidate is compared with a first average candidate and a second average candidate. In some embodiments, the first N average candidates are compared with the first M candidates already in the candidate set, and the rest average candidates are compared with only a first or last candidate in the candidate set, or the rest average candidates are compared with only the generated average candidates.

In yet another embodiment, the average candidate is directly added into the candidate set without performing any full or partial pruning process.

Weighted Average The one or more average candidates generated according to an embodiment of the present invention may be calculated by even weighted average calculation or different weighted average calculation. In an example of different weighted average calculation, when the number of MVs for computing an average candidate is three, one of the MVs may be multiplied by 2 and the sum of the MVs is divided by 4. In an example of even weighted average calculation, when the number of MVs for computing an average candidate is two, the weights for these two MVs are both 1, and the sum of the MVs is then divided by 2. In another example, the weights for two MVs may be 2 and -1 or -1 and 2, and the sum of the two weighted MVs is the average candidate without division. More generally, the weights for the MVs are N₁, N₂, . . . Nₙ and then the sum of the weighted MVs is divided by (N₁+N₂+ . . . +Nₙ). In another embodiment, the weighting factor for each MV associated with a neighboring block depends on a distance between the current block and the neighboring block, for example, a larger weighting factor is assigned to a MV associated with a neighboring block closer to the current block.

Sub-block Candidate Set Various sub-block modes including ATMVP, SbTMVP, and affine MCP, are proposed in the latest video coding standard meetings to improve the coding efficiency, and for a current block coded in a sub-block mode, sub-blocks in the current block may be collected to share a candidate set according to some embodiments. The candidate set shared by the sub-blocks of the current block is called a sub-block mode candidate set. For each block coded in Skip mode, Merge mode, or AMVP mode, a flag may be signaled to indicate whether a sub-block mode is used. If the flag indicates the sub-block mode is used, a candidate index is signaled or inferred to select one of the sub-block candidates in the sub-block mode candidate set. The sub-block mode candidate set may include a sub-block temporal Merge candidate, affine candidate, and/or Planar MV mode candidate. The sub-block temporal Merge candidate may be placed after the affine candidate or affine inherit candidate, and the Planar MV mode candidate may be placed after the affine candidate or before the affine candidate. The one or more average candidate derived according to one embodiment of the present invention may be included in a sub-block mode candidate set.

The sub-block mode may be enabled or disabled for a current block according to a CU size, area, width, height, shape, depth, or CU mode of the current block. A particular sub-block candidate may be adaptively included in the candidate set for coding a current block depending on a CU size, area, width, height, shape, depth, or CU mode of the current block according to an embodiment. For example, when the CU width or height is smaller than (or smaller than or equal to) a threshold, such as 8 or 16, the sub-block mode is disabled, alternatively, the sub-block mode is enabled when the CU width or height is larger than (or larger than or equal to) a threshold, such as 16. In another example, an affine candidate is not included in the candidate set for coding a current block if the CU width or height of the current block is smaller than (or smaller than or equal to) a threshold such as 8 or 16. In another example, when the current CU mode is Skip mode, an affine candidate is not added into the candidate set for coding the current block. In one specific embodiment, signaling of a candidate index is skipped when an affine candidate is not added into the candidate set and the list only contains one candidate, for example, the sub-block temporal Merge candidate. In another embodiment, a sub-block candidate is adaptively inserted into a normal candidate set for Merge mode or AMVP mode according to the CU size, area, width, height, depth, or CU mode, or when the sub-block candidate is available. For example, a sub-block candidate (e.g. the sub-block temporal Merge candidate) is added into the normal Merge candidate set for a current block when the current block is coded in Skip mode or when the CU width or height of the current block is smaller than or equal to 8.

In one embodiment, the sub-block size is the same for all sub-block candidates in the same candidate set. Some examples of the sub-block size are 4×4, 8×8, or any non-square size M×N. A fixed sub-block size is used regardless which candidate is selected from the candidate set. The sub-block size may be adaptively determined according to the CU mode, CU size, area, width, height, depth, or prediction direction.

In another embodiment, for ATMVP candidate derivation, only MVs that will be used by the affine candidate derivation are used to derive an ATMVP candidate, so MV referencing complexity may be reduced.

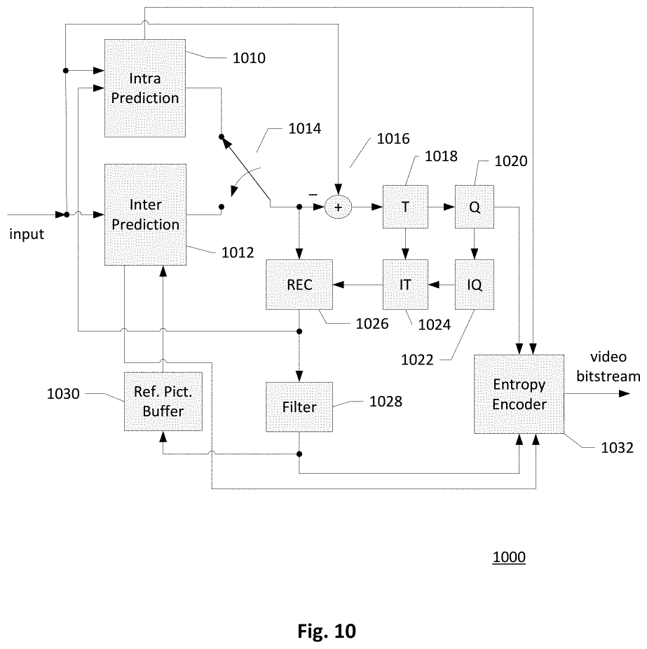

Exemplary Flowchart FIG. 9 illustrates an exemplary flowchart of a video encoding or decoding system for processing a current block coded by inter picture prediction. A current MV associated with the current block and a corresponding reference block in a given reference picture in a given reference list is coded by a Motion Vector Predictor (MVP) selected from a current candidate set. The video encoding or decoding system receives input data of the current block in a current picture in Step S910, and derives one or more motion candidates to be included in the current candidate set for AVMP, Merge, Skip, or Direct mode in Step S920. Each motion candidate in the current candidate set includes one MV for uni-prediction or two MVs for bi-prediction. An average candidate is derived from MVs of a predetermined set of neighboring blocks of the current block in Step S930, where at least one neighboring block used to derive the average candidate is a temporal block in a temporal collocated block. The average candidate includes one MV pointing to a reference picture associated with list 0 or list 1 for uni-prediction, or the average candidate includes one MV pointing to a reference picture associated with list 0 and another MV pointing to a reference picture associated with list 1 for bi-prediction. The video encoding or decoding system performs a full or partial pruning process for the average candidate by checking if the average candidate is identical to one of the motion candidates or the motion candidate existed in the current candidate set in Step S940. In one embodiment, the average candidate is compared with all the motion candidates existed in the current candidate set, and in another embodiment, the average candidate is compared with only one or some of the motion candidates existed in the current candidate set, and in yet another embodiment, the pruning process of Step S940 is skipped as the average candidate is not compared to any motion candidate existed in the current candidate set. If the average candidate is identical to a motion candidate existed in the current candidate, the average candidate is not added to the current candidate set, otherwise, the average candidate is included in the current candidate set in Step S950. The video encoding or decoding system determines one selected candidate from the current candidate set as a MVP for the current MV of the current block in Step S960 and encodes or decodes the current block in inter picture prediction utilizing the MVP in Step S970.

Exemplary Video Encoder and Video Decoder The foregoing proposed video processing methods for generating one or more average candidates to be added in a candidate set can be implemented in video encoders or decoders. For example, a proposed video processing method is implemented in an inter prediction module of an encoder, and/or an inter prediction module of a decoder. Alternatively, any of the proposed methods is implemented as a circuit coupled to the inter prediction module of the encoder and/or the inter prediction module of the decoder, so as to provide the information needed by the inter prediction module. FIG. 10 illustrates an exemplary system block diagram of a Video Encoder 1000 capable of implementing various embodiments of the present invention. Intra Prediction 1010 provides intra predictors based on reconstructed video data of a current picture. Inter Prediction 1012 performs motion estimation (ME) and motion compensation (MC) to provide inter predictors based on video data from one or more reference pictures. To encode a current block in inter picture prediction such as Inter, Merge, Skip, or Direct mode according to some embodiments of the present invention, a current candidate set for encoding the current block is constructed by including an average candidate. Before deriving the average candidate, the current candidate set includes one or more motion candidates, where each motion candidate has one MV for uni-prediction or two MVs for bi-prediction. The average candidate is derived from MVs of at least two neighboring blocks of the current block, and at least one of the neighboring blocks is a temporal block in a temporal collocated picture. Each of the neighboring blocks may be a spatial neighboring block in the current picture or a temporal block in the temporal collocated picture, and the spatial neighboring block may be an adjacent spatial neighboring block or a non-adjacent spatial neighboring block of the current block. The Inter Prediction 1012 determines a selected candidate from the candidate set as a MVP for predicting a current MV of the current block. The current MV of the current block locates a predictor in a given reference picture. Either Intra Prediction 1010 or Inter Prediction 1012 supplies a predictor to Adder 1016 to form prediction errors, the prediction errors are also called prediction residual. The prediction residual is set to zero if the current block is coded in Skip mode. When the current block is not coded in Skip mode, the prediction residual of the current block is further processed by Transformation (T) 1018 followed by Quantization (Q) 1020. The transformed and quantized residual signal is then encoded by Entropy Encoder 1032 to form a video bitstream. The video bitstream is then packed with side information. The transformed and quantized residual signal of the current block is processed by Inverse Quantization (IQ) 1022 and Inverse Transformation (IT) 1024 to recover the prediction residual. As shown in FIG. 10, the prediction residual is recovered by adding back to the selected predictor at Reconstruction (REC) 1026 to produce reconstructed video data. The reconstructed video data may be stored in Reference Picture Buffer (Ref. Pict. Buffer) 1030 and used for prediction of other pictures. The reconstructed video data recovered from REC 1026 may be subject to various impairments due to encoding processing; consequently, In-loop Processing Filter 1028 is applied to the reconstructed video data before storing in the Reference Picture Buffer 1030 to further enhance picture quality.

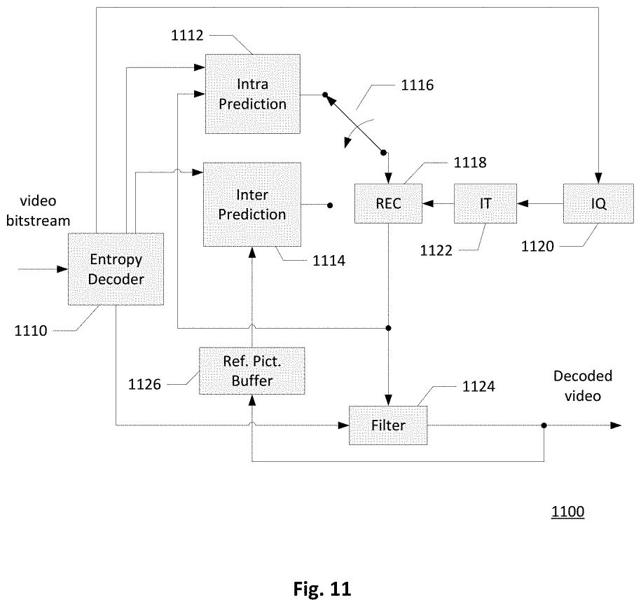

A corresponding Video Decoder 1100 for decoding the video bitstream generated from the Video Encoder 1000 of FIG. 10 is shown in FIG. 11. The video bitstream is the input to Video Decoder 1100 and is decoded by Entropy Decoder 1110 to parse and recover the transformed and quantized residual signal and other system information. The decoding process of Decoder 1100 is similar to the reconstruction loop at Encoder 1000, except Decoder 1100 only requires motion compensation prediction in Inter Prediction 1114. Each block is decoded by either Intra Prediction 1112 or Inter Prediction 1114. Switch 1116 selects an intra predictor from Intra Prediction 1112 or an inter predictor from Inter Prediction 1114 according to decoded mode information. Inter Prediction 1114 of some embodiments constructs a current candidate set for a current block including one or more motion candidates and an average candidate. The average candidate is derived from two or more MVs of neighboring blocks of the current block, and at least one of the neighboring blocks used to derive the average candidate is a temporal block in a temporal collocated picture. A pruning process may be applied to check if the average candidate is redundant comparing to one or more motion candidates existed in the current candidate set. Inter Prediction 1114 derives a predictor for the current block by selecting one final candidate from the current candidate set. The transformed and quantized residual signal associated with a block is recovered by Inverse Quantization (IQ) 1120 and Inverse Transformation (IT) 1122. The recovered residual signal is reconstructed by adding back the predictor in REC 1118 to produce reconstructed video. The reconstructed video is further processed by In-loop Processing Filter (Filter) 1124 to generate final decoded video. If the currently decoded picture is a reference picture for later pictures in decoding order, the reconstructed video of the currently decoded picture is also stored in Ref. Pict. Buffer 1126.

Various components of Video Encoder 1000 and Video Decoder 1100 in FIG. 10 and FIG. 11 may be implemented by hardware components, one or more processors configured to execute program instructions stored in a memory, or a combination of hardware and processor. For example, a processor executes program instructions to control receiving of input data associated with a current picture. The processor is equipped with a single or multiple processing cores. In some examples, the processor executes program instructions to perform functions in some components in Encoder 1000 and Decoder 1100, and the memory electrically coupled with the processor is used to store the program instructions, information corresponding to the reconstructed images of blocks, and/or intermediate data during the encoding or decoding process. The memory in some embodiments includes a non-transitory computer readable medium, such as a semiconductor or solid-state memory, a random access memory (RAM), a read-only memory (ROM), a hard disk, an optical disk, or other suitable storage medium. The memory may also be a combination of two or more of the non-transitory computer readable mediums listed above. As shown in FIGS. 10 and 11, Encoder 1000 and Decoder 1100 may be implemented in the same electronic device, so various functional components of Encoder 1000 and Decoder 1100 may be shared or reused if implemented in the same electronic device.

Embodiments of the video processing method for encoding or decoding may be implemented in a circuit integrated into a video compression chip or program codes integrated into video compression software to perform the processing described above. For examples, determining of a candidate set including an average candidate for coding a current block may be realized in program codes to be executed on a computer processor, a Digital Signal Processor (DSP), a microprocessor, or field programmable gate array (FPGA). These processors can be configured to perform particular tasks according to the invention, by executing machine-readable software codes or firmware codes that defines the particular methods embodied by the invention.

Reference throughout this specification to “an embodiment”, “some embodiments”, or similar language means that a particular feature, structure, or characteristic described in connection with the embodiments may be included in at least one embodiment of the present invention. Thus, appearances of the phrases “in an embodiment” or “in some embodiments” in various places throughout this specification are not necessarily all referring to the same embodiment, these embodiments can be implemented individually or in conjunction with one or more other embodiments. Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

What is claimed is:

1. A method of video processing in a video coding system utilizing a motion vector predictor (MVP) for coding a current motion vector (MV) of a current block coded by inter picture prediction, wherein the current MV is associated with the current block and one corresponding reference block in a given reference picture in a given reference list, the method comprising:
receiving input data associated with the current block in a current picture;
including one or more motion candidates in a current candidate set for the current block, wherein each motion candidate in the current candidate set includes one MV for uni-prediction or two MVs for bi-prediction;
deriving an average candidate by averaging motion information of a predetermined set of neighboring blocks of the current block, wherein the average candidate includes one MV pointing to a reference picture associated with list 0 or list 1 for uni-prediction, or the average candidate includes one MV pointing to a reference picture associated with list 0 and another MV pointing to a reference picture associated with list 1 for bi-prediction, wherein at least one neighboring block used to derive the average candidate is a temporal block in a temporal collocated picture;
including the average candidate in the current candidate set;
determining, from the current candidate set, one selected candidate as a MVP for the current MV of the current block; and
encoding or decoding the current block in inter picture prediction utilizing the MVP.

2. The method of claim 1, wherein each of the neighboring blocks is a spatial neighboring block of the current block in the current picture or a temporal block in the temporal collocated picture, and wherein the spatial neighboring block is an adjacent spatial neighboring block or a non-adjacent spatial neighboring block of the current block.

3. The method of claim 2, wherein the average candidate is derived from averaging MVs of one temporal block and two spatial neighboring blocks, MVs of one temporal block and one spatial neighboring block, MVs of two temporal blocks and one spatial neighboring block, MVs of three temporal blocks and one spatial neighboring block, MVs of two temporal blocks and two spatial neighboring blocks, MVs of one temporal block and three spatial neighboring blocks, or MVs of three temporal blocks and one spatial neighboring block.

4. The method of claim 1, wherein deriving the average candidate by averaging motion information of the neighboring blocks further comprises checking if any of the motion information of the neighboring blocks is unavailable, determining a replacement block to replace the neighboring block with unavailable motion information, and deriving a modified average candidate using the replacement block to replace the average candidate.

5. The method of claim 4, wherein if the neighboring block with unavailable motion information is a spatial neighboring block, the replacement block is a predefined temporal block, a temporal block collocated to the spatial neighboring block, a predefined adjacent spatial neighboring block, or a predefined non-adjacent spatial neighboring block.

6. The method of claim 1, wherein deriving the average candidate by averaging motion information of the neighboring blocks further comprises checking if any of the motion information of the neighboring blocks is unavailable, and setting the average candidate as unavailable if any of the motion information is unavailable.

7. The method of claim 1, wherein deriving the average candidate by averaging motion information of the neighboring blocks further comprises checking if any of the motion information of the neighboring blocks is unavailable, and if any of the motion information is unavailable, deriving a modified average candidate only with the rest available motion information, and replacing the average candidate with the modified average candidate.

8. The method of claim 7, wherein a position of the modified average candidate in the current candidate set is moved backward in comparison to a predefined position for the average candidate.

9. The method of claim 1, wherein the average candidate is derived by one or more motion candidates already included in the current candidate set.

10. The method of claim 9, wherein each of said one or more motion candidates already in the current candidate set used to derive the average candidate is limited to be a spatial motion candidate.

11. The method of claim 1, further comprises deriving and including another average candidate in the current candidate set, and the two average candidates are inserted in the current candidate set in adjacent positions or non-adjacent positions.

12. The method of claim 1, wherein reference picture indexes of all the neighboring blocks for deriving the average candidate equal to a given reference picture index, and the given reference picture index of the given reference picture is predefined, explicitly transmitted in a video bitstream, or implicitly derived from the motion information of the neighboring blocks for generating the average candidate.

13. The method of claim 1, wherein the average candidate is derived by averaging one or more scaled MVs, each scaled MV is computed by scaling one MV of the neighboring block to the given reference picture, and a given reference picture index of the given reference picture is predefined, explicitly transmitted in a video bitstream, or implicitly derived from the MVs for generating the average candidate.

14. The method of claim 13, wherein a number of scaled MVs used to derive the average candidate is constraint by a total scaling count.

15. The method of claim 1, wherein the average candidate is derived by directly averaging MVs of the neighboring blocks without scaling regardless reference picture indexes of the neighboring blocks are same or different.

16. The method of claim 1, wherein deriving an average candidate by averaging motion information of the neighboring blocks further comprising checking if reference picture indexes or Picture order Count (PoC) of the neighboring blocks are different, and directly using one of the neighboring blocks to derive the average candidate without averaging if the reference picture indexes or PoC are different.

17. The method of claim 1, wherein only one of horizontal and vertical components of the average candidate is calculated by averaging corresponding horizontal or vertical components of the motion information of the neighboring blocks, and the other of horizontal and vertical components of the average candidate is directly set to the other of horizontal and vertical components of one of the motion information of the neighboring blocks.

18. The method of claim 1, wherein only a first list MV of the average candidate is calculated by averaging first list MVs of the two or more neighboring blocks, and a second list MV of the average candidate is directly set to a second list MV of one neighboring block, wherein the first and second lists are list 0 and list 1 or list 1 and list 0.

19. The method of claim 1, further comprising comparing the average candidate with one or more motion candidates already existed in the current candidate set, and removing the average candidate from the current candidate set or not including the average candidate in the current candidate set if the average candidate is identical to one motion candidate.

20. The method of claim 19, wherein one or more motion candidates already existed in the current candidate set are used to derive the average candidate, and the average candidate is only compared with partial or all of the motion candidates used to derive the average candidate.

21. The method of claim 19, wherein one or more motion candidates already existed in the current candidate set are used to derive the average candidate, and the average candidate is only compared with partial or all motion candidates not used to generate the average candidate.

22. The method of claim 1, wherein the average candidate is derived by weighted averaging MVs of the neighboring blocks, and weighting factors for the MVs of the neighboring blocks are predefined or implicitly derived.

23. The method of claim 1, wherein the current block is coded in a sub-block mode, and the current candidate set is shared by sub-blocks in the current block.

24. The method of claim 1, wherein the motion information of at least one neighboring block used to derive the average candidate is not one of the motion candidates or the motion candidate already included in the current candidate set.

25. An apparatus of video processing in a video coding system utilizing a motion vector predictor (MVP) for coding a current motion vector (MV) of a current block coded by inter picture prediction, wherein the current MV is associated with the current block and one corresponding reference block in a given reference picture in a given reference list, the apparatus comprising one or more electronic circuits configured for:
receiving input data associated with the current block in a current picture;
deriving one or more motion candidates and including said one or more motion candidates in a current candidate set for the current block, wherein each motion candidate in the current candidate set includes one MV for uni-prediction or two MVs for bi-prediction;
deriving an average candidate by averaging motion information of a predetermined set of neighboring blocks of the current block, wherein the average candidate includes one MV pointing to a reference picture associated with list 0 or list 1 for uni-prediction, or the average candidate includes one MV pointing to a reference picture associated with list 0 and another MV pointing to a reference picture associated with list 1 for bi-prediction, wherein at least one neighboring block used to derive the average candidate is a temporal block in a temporal collocated picture;
including the average candidate in the current candidate set;
determining, from the current candidate set, one selected candidate as a MVP for the current MV of the current block; and
encoding or decoding the current block in inter picture prediction utilizing the MVP.

26. A non-transitory computer readable medium storing program instruction causing a processing circuit of an apparatus to perform video processing method in a video coding system utilizing a motion vector predictor (MVP) for coding a current motion vector (MV) of a current block coded by inter picture prediction, wherein the current MV is associated with the current block and one corresponding reference block in a given reference picture in a given reference list, and the method comprising:
receiving input data associated with the current block in a current picture;
deriving one or more motion candidates and including said one or more motion candidates in a current candidate set for the current block, wherein each motion candidate in the current candidate set includes one MV for uni-prediction or two MVs for bi-prediction;
deriving an average candidate by averaging motion information of a predetermined set of neighboring blocks of the current block, wherein the average candidate includes one MV pointing to a reference picture associated with list 0 or list 1 for uni-prediction, or the average candidate includes one MV pointing to a reference picture associated with list 0 and another MV pointing to a reference picture associated with list 1 for bi-prediction, wherein at least one neighboring block used to derive the average candidate is a temporal block in a temporal collocated picture;
including the average candidate in the current candidate set;
determining, from the current candidate set, one selected candidate as a MVP for the current MV of the current block; and
encoding or decoding the current block in inter picture prediction utilizing the MVP.
